(19) United States
(12) Patent Application Publication
(10) Pub. No.: US 2021/0162573 A1
(43) Pub. Date: Jun. 3, 2021

(54) DRIVING-IN DEVICE

(71) Applicant: Hilti Aktiengesellschaft, Schaan (LI)

(72) Inventors: Iwan WOLF, Untervaz (CH); Dominik SCHMIDT, Frastanz (AT); Mario GRAZIOLI, Chur (CH); Kurt BAUERNFEIND, Bludesch (AT)

(21) Appl. No.: 16/770,685

(22) PCT Filed: Dec. 5, 2018
(86) PCT No.: PCT/EP2018/083575

§ 371 Date: Jun. 8, 2020

(30) Foreign Application Priority Data
Dec. 21, 2017 (EP) 17209533.3

(51) Int. Cl. B25C 1/06; B25F 5/00

(52) U.S. Cl. CPC B25C 1/06; B25F 5/006; B25F 5/008

(57) ABSTRACT

An apparatus for driving a fastening element into an underlying surface in a driving-in direction is provided, the apparatus having a motor, a support structure that supports the motor, a fan that cools the motor, and one or more damping elements.

### TECHNICAL FIELD

The application relates to an apparatus for driving a fastening element into an underlying surface.

### PRIOR ART

Such apparatuses usually have a piston for transmitting energy to the fastening element. The energy required for this has to be made available in a very short time, which is why, for example in the case of what are known as spring nailers, first of all a spring is tensioned, said spring, during the driving-in operation, imparting the tensile energy to the piston in a sudden burst and accelerates the latter onto the fastening element. The energy released in a sudden burst, with which the fastening element is driven into the underlying surface, causes a recoil, which mechanically loads some components of such apparatuses.

### SUMMARY OF THE INVENTION

One aspect of the application relates to an apparatus for driving a fastening element into an underlying surface in a driving-in direction, having a motor, having a support structure that supports the motor, and having a damping element, by means of which the motor is held on the support structure. The damping element comprises a ring element, which fits around the motor in a plane extending preferably perpendicularly to the driving-in direction. Such an arrangement of the damping element gives the motor a large amount of freedom of movement in the driving-in direction relative to the support structure.

One advantageous configuration is characterized in that the motor is held on the support structure only by means of the damping element and is otherwise motionally decoupled in the driving-in direction relative to the support structure. Preferably, the motor is otherwise motionally decoupled in all directions relative to the support structure.

One advantageous configuration is characterized in that the ring element comprises an elastic material, preferably an elastomer, in particular PU, EPDM or FKM. Preferably, the ring element consists thereof.

One advantageous configuration is characterized in that the ring element is in the form of a circular ring. A further advantageous configuration is characterized in that the ring element has an elliptical, in particular circular, cross section in the circumferential direction.

One advantageous configuration is characterized in that the apparatus has a housing, wherein the support structure is rigidly connected to the housing or is part of the housing.

One advantageous configuration is characterized in that the support structure has a groove for partially receiving the ring element. Preferably, the groove extends in the circumferential direction of the ring element. A further advantageous configuration is characterized in that the motor has a channel for partially receiving the ring element. Preferably, the channel extends in the circumferential direction of the ring element.

One advantageous configuration is characterized in that the apparatus comprises an energy transmission element that is movable between a starting position and a setting position in order to transmit energy to the fastening element.

One advantageous configuration is characterized in that the apparatus has a mechanical energy store for storing mechanical energy and an energy transmission device for transmitting energy from an energy source to the mechanical energy store, wherein the energy transmission device has the motor for transmitting the energy from the energy source to the mechanical energy store. Preferably, the mechanical energy store comprises a spring.

A further aspect of the application relates to an apparatus for driving a fastening element into an underlying surface in a driving-in direction, having a heat source, having a fan for cooling the heat source, having a support structure that supports the fan, and having a fan damping element, by means of which the fan is held on the support structure or on the heat source.

One advantageous configuration is characterized in that the apparatus comprises a further damping element, by means of which the heat source is held on the support structure.

One advantageous configuration is characterized in that the fan has an enclosure, which is formed by the fan damping element.

One advantageous configuration is characterized in that the fan damping element has at least one protrusion, wherein the support structure, or the heat source, has a receptacle in which the protrusion is received. Preferably, the receptacle has an undercut, in which the protrusion engages.

One advantageous configuration is characterized in that the fan damping element and/or the further damping element comprises an elastic material, preferably an elastomer, in particular PU, EPDM or FKM. Preferably, the fan damping element consists thereof.

One advantageous configuration is characterized in that the apparatus has a housing, wherein the support structure is rigidly connected to the housing or is part of the housing.

One advantageous configuration is characterized in that the apparatus comprises an energy transmission element that is movable between a starting position and a setting position in order to transmit energy to the fastening element.

One advantageous configuration is characterized in that the heat source comprises a motor, preferably an electric motor.

One advantageous configuration is characterized in that the apparatus has a mechanical energy store for storing mechanical energy and an energy transmission device for transmitting energy from an energy source to the mechanical energy store, wherein the energy transmission device has the motor for transmitting the energy from the energy source to the mechanical energy store. Preferably, the mechanical energy store comprises a spring, particularly preferably a helical spring.

One advantageous configuration is characterized in that the energy source comprises an electric battery, which supplies the motor and the fan with electrical energy.

### EXEMPLARY EMBODIMENTS

Exemplary embodiments of an apparatus for driving a fastening element into an underlying surface are explained in more detail in the following text by way of examples with reference to the drawings, in which:

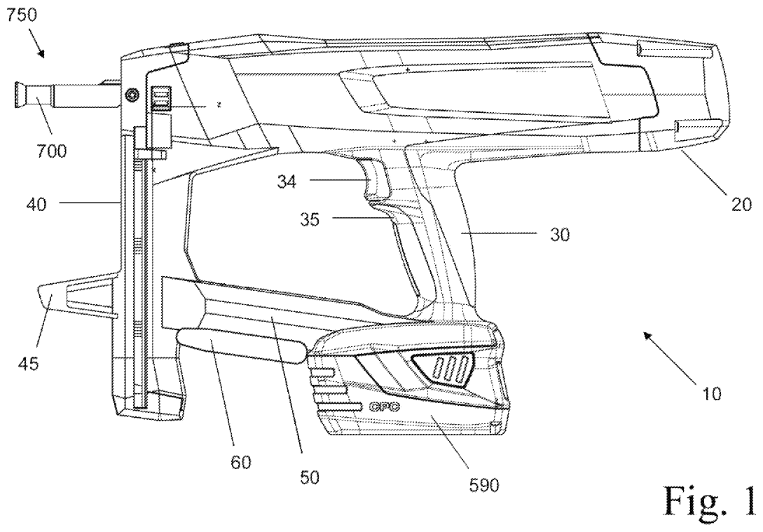

FIG. 1 shows a side view of a driving-in apparatus,

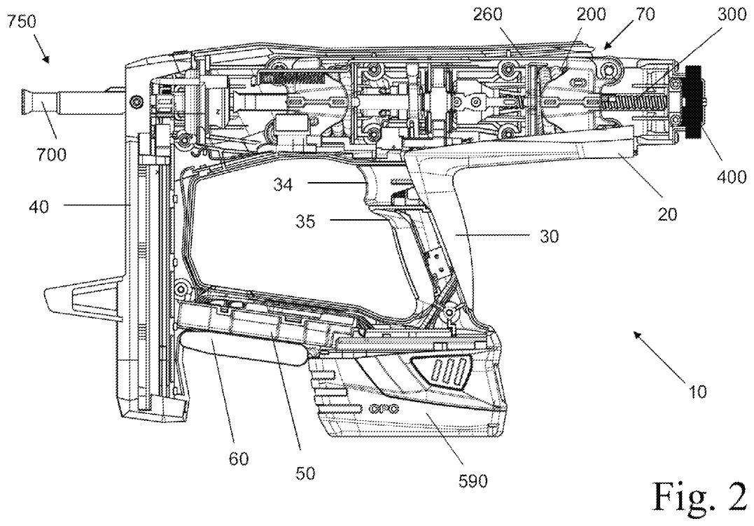

FIG. 2 shows a side view of a driving-in apparatus with the housing open,

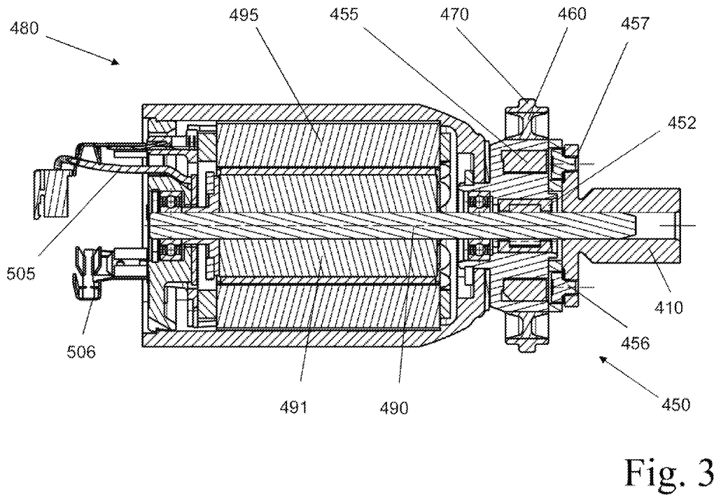

FIG. 3 shows a longitudinal section through an electric motor,

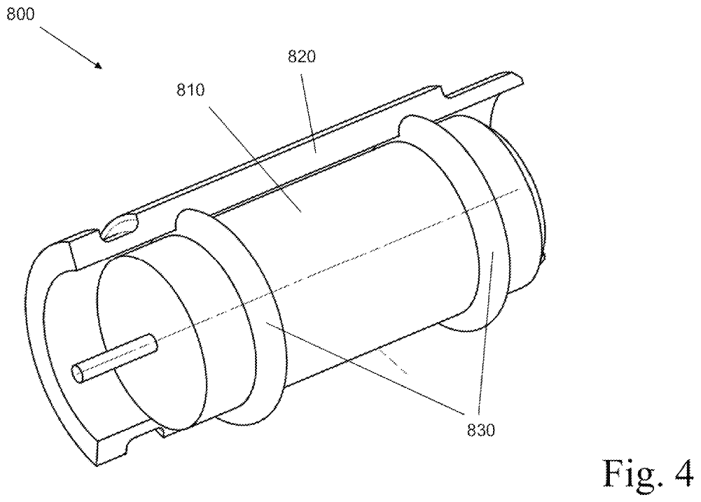

FIG. 4 shows a perspective view of an electric motor,

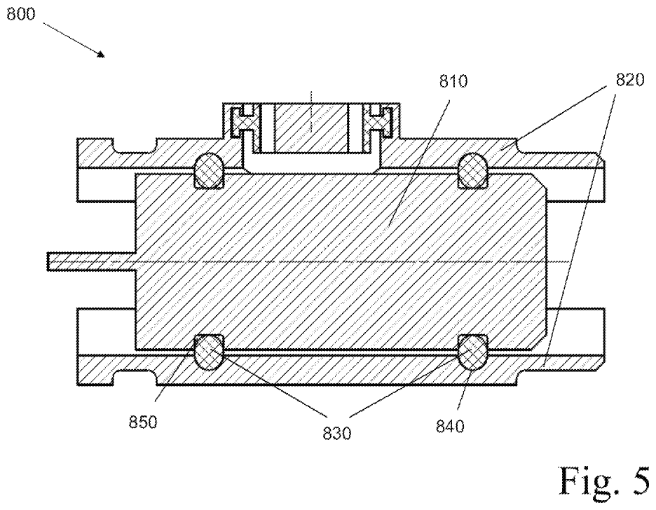

FIG. 5 shows a longitudinal section through the electric motor in FIG. 4, and

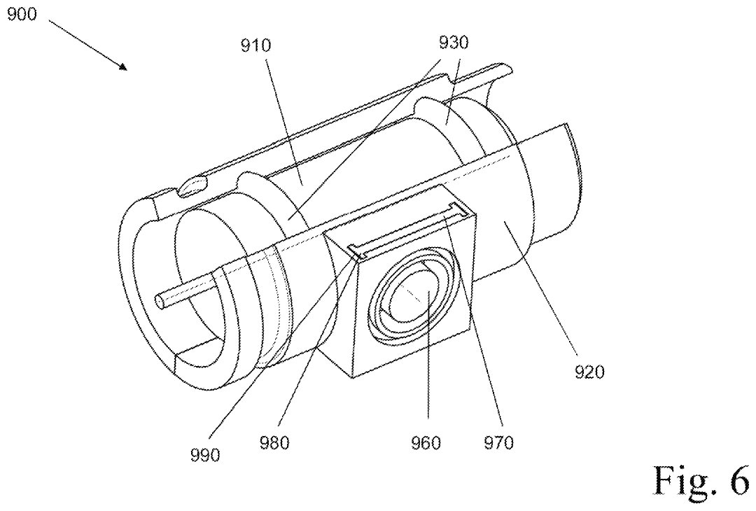

FIG. 6 shows a perspective view of an electric motor having a fan.

FIG. 1 shows a side view of a driving-in apparatus 10 for driving a fastening element, for example a nail or bolt, into an underlying surface. The driving-in apparatus 10 has an energy transmission element (not illustrated) for transmitting energy to the fastening element, and a housing 20, in which the energy transmission element and a drive device (likewise not illustrated) for advancing the energy transmission element are received.

The driving-in apparatus 10 also has a handle 30, a magazine 40 and a bridge 50 connecting the handle 30 to the magazine 40. The magazine is not removable. Fastened to the bridge 50 are a scaffold hook 60 for hanging the driving-in apparatus 10 on a scaffold or the like, and an electrical energy store in the form of a rechargeable battery 590. Arranged on the handle 30 are a trigger 34 and a grip sensor in the form of a manual switch 35. Furthermore, the driving-in apparatus 10 has a guide duct 700 for guiding the fastening element and a pressing device 750 for identifying a distance of the driving-in apparatus 10 from an underlying surface (not illustrated). Alignment of the driving-in apparatus perpendicularly to an underlying surface is assisted by an alignment aid 45.

FIG. 2 shows the driving-in apparatus 10 with the housing 20 open. Received in the housing 20 is a drive device 70 for moving an energy transmission element that is concealed in the drawing. The drive device 70 comprises an electric motor (not illustrated) for converting electrical energy from the rechargeable battery 590 into rotational energy, a torque transmission device, comprising a gear mechanism 400, for transmitting a torque of the electric motor to a motion converter in the form of a spindle drive 300, a force transmission device, comprising a roller train 260, for transmitting a force from the motion converter to a mechanical energy store in the form of a spring 200 and for transmitting a force from the spring to the energy transmission element.

FIG. 3 shows an electric motor 480 having a motor output 490 in longitudinal section. The motor 480 is in the form of a brushless DC motor and has motor coils 495 for driving the motor output 490, which comprises a permanent magnet 491. The motor 480 is held by a motor holder (not illustrated) and supplied with electrical energy by means of the crimp contacts 506 and controlled by means of the control line 505.

A motor-side rotary element, in the form of a motor pinion 410, is fastened to the motor output 490 so as to rotate therewith by way of a interference fit. In exemplary embodiments that are not illustrated, the rotary element is fastened in a materially bonded manner, in particular by adhesive bonding or injection-molding, or in a form-fitting manner. The motor pinion 410 is driven by the motor output 490 and for its part drives a torque transmission device (not illustrated). A holding device 450 is mounted in a rotatable manner on the motor output 490 by means of a bearing 452 and is also attached to the motor housing in a rotationally fixed manner by means of an annular mounting element 470. Arranged between the holding device 450 and the mounting element 470 is a likewise annular sealing element 460, which serves for sealing with respect to dust and the like. Together with the line seal 570, the motor housing 24 is sealed off from the rest of the housing, wherein the fan 565 draws in air for cooling the motor 480 through the ventilation slots 33 and the rest of the drive device is protected from dust.

The holding device 450 has a solenoid 455, which, when energized, exerts an attractive force on one or more solenoid armatures 456. The solenoid armatures 456 extend in armature recesses 457, in the form of apertures, in the motor pinion 410 and are thus arranged on the motor pinion 410, and thus on the motor output 490, so as to rotate therewith. On account of the attractive force, the solenoid armatures 456 are pushed against the holding device 450, such that a rotary movement of the motor output 490 with respect to the motor housing is braked or prevented.

FIG. 4 shows a further example of a driving-in apparatus 800 having a motor 810 and a support structure 820, which is part of a housing of the driving-in apparatus 800 and supports the motor 810, which is held on the support structure 820 by means of two damping elements 830 in the form of ring elements. The damping elements 830 each fit around the motor 810 in a plane extending perpendicularly to the driving-in direction of the driving-in apparatus. Otherwise, the motor 810 is motionally decoupled in all directions relative to the support structure 820. The damping elements 830 consist of an elastomer and are in the form of a circular ring. They have a circular cross section and are in the form of O-rings.

FIG. 5 shows a sectional view of the arrangement in FIG. 4. The support structure 820 has grooves 840 for partially receiving in each case one damping element 830, wherein each groove 840 is formed in a manner extending all the way round the particular damping element 830 in the circumferential direction. Similarly, the motor 810 has two channels 850 for partially receiving in each case one damping element 830, wherein each channel 850 is formed in a manner extending all the way round the particular damping element 830 in the circumferential direction.

FIG. 6 shows a further example of a driving-in apparatus 900 having a motor 910 and a support structure 920, which is part of a housing of the driving-in apparatus 900 and supports the motor 910, which is held on the support structure 920 by means of two damping elements 930 in the form of ring elements. The damping elements 930 each fit around the motor 910 in a plane extending perpendicularly to the driving-in direction of the driving-in apparatus. The damping elements 830 consist of an elastomer and are in the form of a circular ring. They have a circular cross section and are in the form of O-rings.

In order to cool the motor 910, which represents a heat source, the driving-in apparatus 900 has a fan 960, which is driven by the same energy source as the motor 910 and is held on the support structure 920 by means of a fan damping element 970. In an exemplary embodiment that is not shown, the fan is held on the motor by means of the fan damping element and is thus additionally damped by means of the damping element of the motor.

The fan damping element 970 consists of an elastomer and forms an enclosure of the fan 960 and has a preferably T-shaped protrusion 980, which is received in a receptacle 990 of the support structure 920. In this case, the protrusion 980 engages in an undercut of the receptacle.

The invention has been described by way of a series of exemplary embodiments. The individual features of the various exemplary embodiments are applicable individually or in any desired combination with one another, provided that they are not contradictory. It should be noted that the driving-in apparatus according to the invention is also usable for other applications.

1. An apparatus for driving a fastening element into an underlying surface in a driving-in direction, the apparatus having a heat source; a fan for cooling the heat source; a support structure that supports the fan, and a fan damping element, by which the fan is held on the support structure or on the heat source.

2. The apparatus as claimed in claim 1, also comprising a further damping element, by which the heat source is held on the support structure.

3. The apparatus as claimed in claim 1, wherein the fan has an enclosure, which is formed by the fan damping element.

4. The apparatus as claimed in claim 1, wherein the fan damping element has at least one protrusion, and wherein the support structure, or the heat source, has a receptacle in which the protrusion is received.

5. The apparatus as claimed in claim 4, wherein the receptacle has an undercut in which the protrusion engages.

6. The apparatus as claimed in claim 1, wherein the fan damping element and/or the further damping element comprises an elastic material.

7. The apparatus as claimed in claim 1, also having a housing, wherein the support structure is rigidly connected to the housing or is part of the housing.

8. The apparatus as claimed in claim 1, wherein the heat source comprises an electric motor.

9. The apparatus as claimed in claim 1, also comprising an energy transmission element that is movable between a starting position and a setting position in order to transmit energy to the fastening element.

10. The apparatus as claimed in claim 1, also having a mechanical energy store for storing mechanical energy and an energy transmission device for transmitting energy from an energy source to the mechanical energy store, wherein the energy transmission device has the motor for transmitting the energy from the energy source to the mechanical energy store.

11. The apparatus as claimed in claim 10, wherein the mechanical energy store comprises a spring.

12. The apparatus as claimed in claim 10, wherein the energy source comprises an electric battery, which supplies the motor and the fan with electrical energy.

13. The application of claim 6, wherein the elastic material comprises an elastomer.

14. The application of claim 13, wherein the elastomer comprises PU, EPDM or FKM.

15. The application of claim 14, wherein the elastomer consists of PU, EPDM or FKM.

16. The application of claim 11, wherein the spring comprises a helical spring.

17. The apparatus as claimed in claim 2, wherein the fan has an enclosure, which is formed by the fan damping element.

18. The apparatus as claimed in claim 2, wherein the fan damping element has at least one protrusion, and wherein the support structure, or the heat source, has a receptacle in which the protrusion is received.

19. The apparatus as claimed in claim 3, wherein the fan damping element has at least one protrusion, and wherein the support structure, or the heat source, has a receptacle in which the protrusion is received.

20. The apparatus as claimed in claim 2, wherein the fan damping element and/or the further damping element comprises an elastic material.
